(19) United States
(12) Patent Application Publication
(10) Pub. No.: US 2026/0353207 A1
(43) Pub. Date: Nov. 5, 2026

(54) NODE AND USER EQUIPMENT IN WIRELESS COMMUNICATION SYSTEM AND METHOD PERFORMED BY THE SAME

(71) Applicant: Samsung Electronics Co., Ltd., Suwon-si, Gyeonggi-do (KR)

(72) Inventors: Runsen TANG, Beijing (CN); Yanze FU, Beijing (CN); He WANG, Beijing (CN)

(21) Appl. No.: 19/483,959

(22) PCT Filed: May 8, 2024
(86) PCT No.: PCT/KR2024/006141

§ 371 Date: Nov. 12, 2025

(30) Foreign Application Priority Data
May 12, 2023 (CN) 202310540094.0

(51) Int. Cl. H04W 36/00; H04B 7/06

(52) U.S. Cl. CPC H04W 36/0077; H04B 7/0626; H04W 36/0072

(57) ABSTRACT

The disclosure relates to a 5G or 6G communication system for supporting a higher data transmission rate. The present disclosure provides a node and a user equipment in a wireless communication system and methods performed by the same. A method performed by a user equipment (UE) includes receiving, from a node, a first message for indicating the UE to perform cell handover, and performing uplink transmission to a target cell within first handover time from the end of a last transmission time interval including the first message, where the first handover time includes first time including time related to antenna steering required by the UE during handover, the first time being determined based on information associated with an antenna configuration of the UE.

### TECHNICAL FIELD

The present disclosure relates to a technical field of wireless communication, and more specifically, to a node and a user equipment in a wireless communication system and methods performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The embodiments of the present disclosure provides a time interval, which corresponds to the UE behavior, in handover interruption time for this UE to steer its antenna during the handover.

The embodiments of the present disclosure provides that the time interval is based on the UE type, each UE type corresponds to a time interval.

The embodiments of the present disclosure provides that the UE type is transmitted by UE capability to indicate its antenna steering capability.

The embodiments of the present disclosure provides that the UE type is categorized based on antenna steering type.

The embodiments of the present disclosure provides that the UE indicating its antenna steering type via UE capability.

### Solution to Problem

Embodiments of the present disclosure provide a method performed by a user equipment (UE) in a wireless communication system, including receiving, from a node, a first message for indicating the UE to perform cell handover; and performing uplink transmission to a target cell within first handover time from the end of a last transmission time interval including the first message, where the first handover time includes first time including time related to antenna steering required by the UE during handover and/or time required for circuit switching between different antennas, where the first time is determined based on information associated with an antenna configuration of the UE.

According to embodiments of the present disclosure, the first time is determined based on one or more of: a quantity of times of steering a UE antenna during handover, time required for the UE antenna to perform single antenna steering during handover, a quantity of times for the UE to perform circuit switching between antennas during handover, and time required for the UE antenna to perform single circuit switching during handover.

According to embodiments of the present disclosure, the first handover time includes first interruption time, where the first interruption time includes first search time required to search for a target cell when the UE receives the first message and the target cell is unknown, and where the first search time is determined based on the information associated with the antenna configuration of the UE.

According to embodiments of the present disclosure, the first time is included in the first interruption time.

According to embodiments of the present disclosure, if the target cell is a Frequency Range 2 cell, the first search time is determined based on an N value and a synchronization signal block-based measurement timing configuration (SMTC) cycle of the target cell, where the N value is determined based on the information associated with the antenna configuration of the UE, where the N value is an integer greater than or equal to 0.

According to embodiments of the present disclosure, if the information associated with the antenna configuration of the UE indicates that the UE is a UE that needs to perform mechanical steering to adjust antenna alignment, the N value is equal to 1.

According to embodiments of the present disclosure, if the information associated with the antenna configuration of the UE indicates that the UE is a UE that needs to perform mechanical steering to adjust antenna alignment, the first search time is determined based on a synchronization signal block-based measurement timing configuration (SMTC) cycle of the target cell.

Embodiments of the present disclosure provide a method performed by a user equipment (UE) in a wireless communication system, including: receiving a first reference signal, where the first reference signal is used for at least one of radio link monitoring, beam failure detection, or candidate beam detection; and evaluating the first reference signal within first evaluation time, where the first evaluation time is determined based on information associated with an antenna configuration of the UE.

According to embodiments of the present disclosure, the first evaluation time is determined based on scaling factor, and where the scaling factor is determined based on at least one of a frequency range, an application scenario, or the information associated with the antenna configuration of the UE.

According to embodiments of the present disclosure, in a case that the first reference signal is a reference signal for radio link monitoring, beam failure detection, and/or candidate beam detection of a satellite access node (SAN) cell, and the information associated with the antenna configuration of the UE indicates that the UE is a UE that needs to perform mechanical steering to adjust antenna alignment, the scaling factor is 1.

According to embodiments of the present disclosure, in a case that the first reference signal is a reference signal for candidate beam detection of a satellite access node (SAN) cell, and the information associated with the antenna configuration of the UE indicates that the UE is a UE that needs to perform mechanical steering to adjust antenna alignment, the first evaluation time further includes additional time for the UE to perform antenna steering.

According to embodiments of the present disclosure, the information associated with the antenna configuration of the UE includes one or more of: indicating a UE that uses an omni-directional antenna and does not need to perform mechanical steering to adjust antenna alignment; indicating a UE that uses a phased array antenna and does not need to perform mechanical steering to adjust antenna alignment; indicating a UE that uses a single phased array or a single parabolic antenna and needs to perform mechanical steering to adjust antenna alignment; indicating a UE that uses a plurality of antennas, needs to perform circuit switching between the antennas, and needs to perform mechanical steering to adjust antenna alignment, where each of the plurality of antennas includes a phased array or parabolic antenna; indicating a UE that uses a plurality of phased array and/or parabolic antennas, does not need to perform circuit switching between the antennas, and needs to perform mechanical steering to adjust antenna alignment.

According to embodiments of the present disclosure, the information associated with the antenna configuration of the UE includes one or more of: indicating a type of an antenna used by the UE; and indicating a quantity of antennas used by the UE, where the type includes an omni-directional antenna, a phased array antenna, or a parabolic antenna, and the quantity includes one or more.

According to embodiments of the present disclosure, the information associated with the antenna configuration of the UE further includes at least one of: indicating that the UE needs to perform circuit switching between antennas; indicating that the UE does not need to perform circuit switching between antennas; indicating that the UE needs to perform mechanical steering to adjust antenna alignment; or indicating that the UE does not need to perform mechanical steering to adjust antenna alignment.

According to embodiments of the present disclosure, the first reference signal includes at least one of a synchronization signal block (SSB) or a channel state information reference signal (CSI-RS).

Embodiments of the present disclosure provide a method performed by a node in a wireless communication system, including: transmitting, to a user equipment (UE), a first message for indicating the UE to perform cell handover, where the UE performs uplink transmission to a target cell within first handover time from the end of a last transmission time interval including the first message, where the first handover time includes first time including time related to antenna steering required by the UE during handover and/or time required for circuit switching between different antennas, where the first time is determined based on information associated with an antenna configuration of the UE.

According to embodiments of the present disclosure, the first time is determined based on one or more of: a quantity of times of steering a UE antenna during handover, time required for the UE antenna to perform single antenna steering during handover, a quantity of times for the UE to perform circuit switching between antennas during handover, and time required for the UE antenna to perform single circuit switching during handover.

According to embodiments of the present disclosure, the first handover time includes first interruption time, where the first interruption time includes first search time required to search for a target cell when the UE receives the first message and the target cell is unknown, and where the first search time is determined based on the information associated with the antenna configuration of the UE.

According to embodiments of the present disclosure, the first time is included in the first interruption time.

According to embodiments of the present disclosure, if the target cell is a Frequency Range 2 cell, the first search time is determined based on an N value and a synchronization signal block-based measurement timing configuration (SMTC) cycle of the target cell, where the N value is determined based on the information associated with the antenna configuration of the UE, where the N value is an integer greater than or equal to 0.

According to embodiments of the present disclosure, if the information associated with the antenna configuration of the UE indicates that the UE is a UE that needs to perform mechanical steering to adjust antenna alignment, the N value is equal to 1.

According to embodiments of the present disclosure, if the information associated with the antenna configuration of the UE indicates that the UE is a UE that needs to perform mechanical steering to adjust antenna alignment, the first search time is determined based on a synchronization signal block-based measurement timing configuration (SMTC) cycle of the target cell.

Embodiments of the present disclosure provide a method performed by a node in a wireless communication system, including: transmitting, to a user equipment (UE), a first reference signal, where the first reference signal is used for at least one of radio link monitoring, beam failure detection, or candidate beam detection, where the UE evaluates the first reference signal within first evaluation time, where the first evaluation time is determined based on information associated with an antenna configuration of the UE.

According to embodiments of the present disclosure, the first evaluation time is determined based on scaling factor, and where the scaling factor is determined based on at least one of a frequency range, an application scenario, or the information associated with the antenna configuration of the UE.

According to embodiments of the present disclosure, in a case that the first reference signal is a reference signal for radio link monitoring, beam failure detection, and/or candidate beam detection of a satellite access node (SAN) cell, and the information associated with the antenna configuration of the UE indicates that the UE is a UE that needs to perform mechanical steering to adjust antenna alignment, the scaling factor is 1.

According to embodiments of the present disclosure, in a case that the first reference signal is a reference signal for candidate beam detection of a satellite access node (SAN) cell, and the information associated with the antenna configuration of the UE indicates that the UE is a UE that needs to perform mechanical steering to adjust antenna alignment, the first evaluation time further includes additional time for the UE to perform antenna steering.

According to embodiments of the present disclosure, the information associated with the antenna configuration of the UE includes one or more of: indicating a UE that uses an omni-directional antenna and does not need to perform mechanical steering to adjust antenna alignment; indicating a UE that uses a phased array antenna and does not need to perform mechanical steering to adjust antenna alignment; indicating a UE that uses a single phased array or a single parabolic antenna and needs to perform mechanical steering to adjust antenna alignment; indicating a UE that uses a plurality of antennas, needs to perform circuit switching between the antennas, and needs to perform mechanical steering to adjust antenna alignment, where each of the plurality of antennas includes a phased array or parabolic antenna; indicating a UE that uses a plurality of phased array and/or parabolic antennas, does not need to perform circuit switching between the antennas, and needs to perform mechanical steering to adjust antenna alignment.

According to embodiments of the present disclosure, the information associated with the antenna configuration of the UE includes one or more of: indicating a type of an antenna used by the UE; and indicating a quantity of antennas used by the UE, where the type includes an omni-directional antenna, a phased array antenna, or a parabolic antenna, and the quantity includes one or more.

According to embodiments of the present disclosure, the information associated with the antenna configuration of the UE further includes at least one of: indicating that the UE needs to perform circuit switching between antennas; indicating that the UE does not need to perform circuit switching between antennas; indicating that the UE needs to perform mechanical steering to adjust antenna alignment; or indicating that the UE does not need to perform mechanical steering to adjust antenna alignment.

According to embodiments of the present disclosure, the first reference signal includes at least one of a synchronization signal block (SSB) or a channel state information reference signal (CSI-RS).

Embodiments of the present disclosure provide a user equipment (UE) in a wireless communication system, including: a transceiver configured to transmit and receive a signal; and a controller coupled with the transceiver and configured to perform a method performed by the user equipment (UE) in the wireless communication system according to embodiments of the present disclosure.

Embodiments of the present disclosure provide a node in a wireless communication system, including: a transceiver configured to transmit and receive a signal; and a controller coupled with the transceiver and configured to perform a method performed by the node in the wireless communication system according to embodiments of the present disclosure.

Embodiments of the present disclosure provide a computer-readable medium having stored computer-readable instructions thereon, which when executed by a processor, are used to implement the method performed by the user equipment (UE) and/or the node in the wireless communication system according to embodiments of the present disclosure.

In some methods according to embodiments of the present disclosure, a handover mechanism is enhanced based on the information associated with the antenna configuration of the UE, and the enhanced handover mechanism can be compatible with UEs with different antenna configurations to complete handover, and different time intervals are determined based on the antenna configurations of the UEs. This can improve the compatibility of the communication system, shorten the overall handover time and improve the overall communication efficiency. In addition, some methods according to embodiments of the present disclosure can shorten the evaluation or measurement time of a UE with a specific antenna configuration by enhancing reference signal evaluation or measurement based on the information associated with the antenna configuration of the UE, so as to improve the overall efficiency of the communication system.

### BRIEF DESCRIPTION OF DRAWINGS

The above and other aspects, features and advantages of some embodiments of the present disclosure will be more apparent from the following descriptions with reference to the accompanying drawings, in which:

FIG. 1 illustrates an example wireless network according to various embodiments of the present disclosure;

FIG. 2a and FIG. 2b illustrate example wireless transmission and reception paths according to the present disclosure;

FIG. 3a illustrates an example UE according to the present disclosure;

FIG. 3b illustrates an example gNB according to the present disclosure;

FIG. 4 illustrates an example interaction flow between a UE and a network regarding a UE type according to embodiments of the present disclosure;

FIG. 5a illustrates a flowchart of a method performed by a user equipment in a wireless communication system according to embodiments of the present disclosure;

FIG. 5b illustrates a flowchart of a method performed by a user equipment in a wireless communication system according to embodiments of the present disclosure;

FIG. 6a illustrates a flowchart of a method performed by a node in a wireless communication system according to embodiments of the present disclosure;

FIG. 6b illustrates a flowchart of a method performed by a node in a wireless communication system according to embodiments of the present disclosure;

FIG. 7 illustrates a schematic diagram of a user equipment in a wireless communication system according to embodiments of the present disclosure; and

FIG. 8 illustrates a schematic diagram of a node in a wireless communication system according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Technical schemes of embodiments of the present application can be applied to various communication systems, such as the Global System for Mobile Communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, 5th generation (5G) system or new radio (NR), etc. In addition, technical schemes of embodiments of the present application can be applied to future-oriented communication technologies.

Embodiments of the present disclosure are further described below with reference to the accompanying drawings.

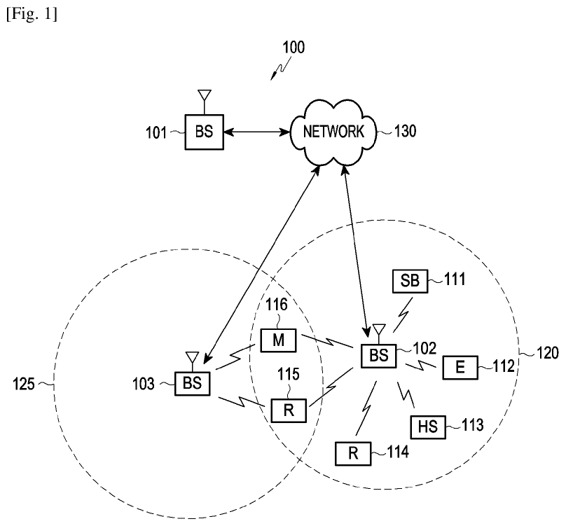

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes base stations (for example, a gNodeB (gNB) 101, a gNB 102, and a gNB 103). The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

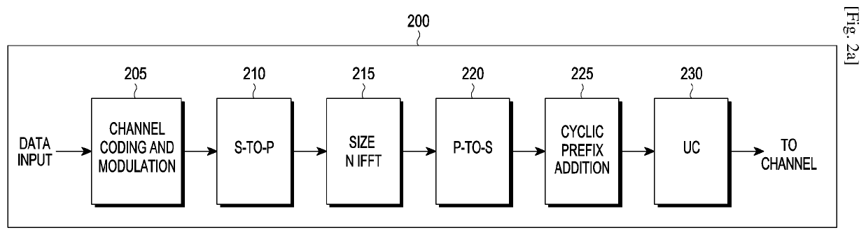

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

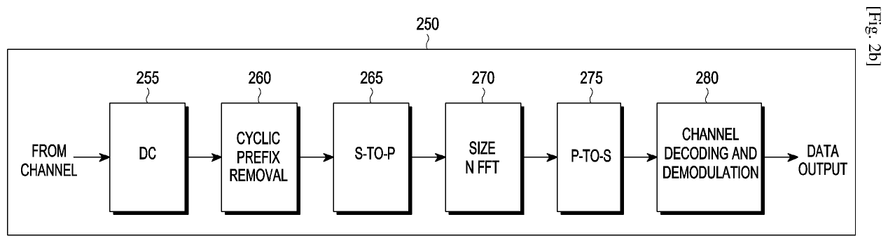

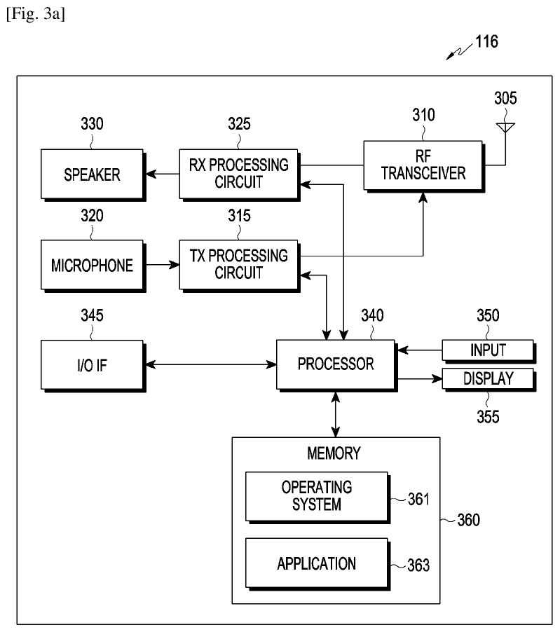

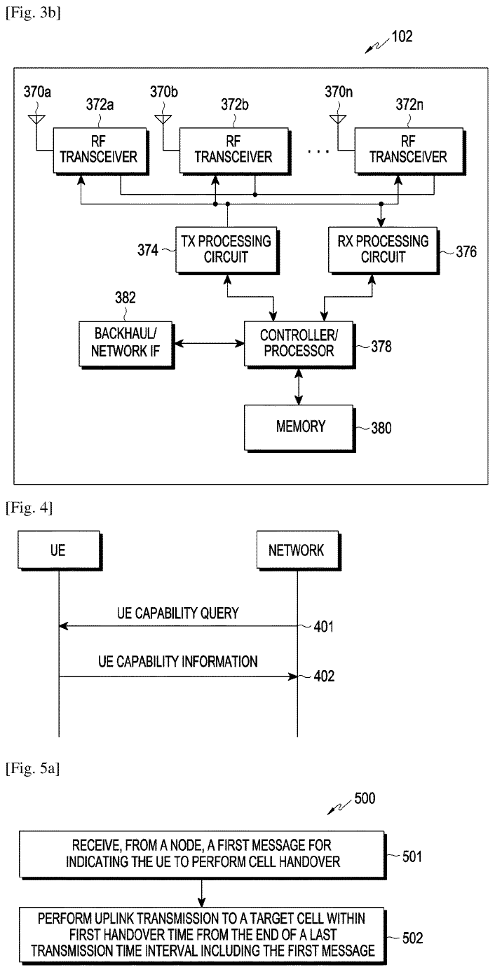

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

With the development of the 5G system, in order to provide users with better communication services, such as providing communication services at any time and any place, especially in scenes with coverage areas such as mountains, oceans, deserts, etc., due to the advantages of longer communication distance and larger coverage area, a satellite communication system is introduced into the 5G communication system. According to types and orbital heights of satellites, satellite communication systems may be divided into a synchronous orbit or Geostationary Earth orbit (GEO for short) satellite communication system and a non-synchronous orbit or Non Geostationary Satellites communication system. The non-synchronous orbit satellite communication system may be further divided into a Medium Earth Orbit (MEO for short) satellite communication system and a Low Earth Orbit (LEO for short) satellite communication system based on the orbit heights of satellites. Embodiments of the present disclosure relate to a method and device for performing cell measurement of a convergence network in a communication system. In the present disclosure, cells of the convergence network include cells of different types of networks, such as, but not limited to, terrestrial network cells, non-terrestrial network cells, macro cells, micro cells, and the like.

A user equipment (UE) may be configured with one or more antennas. Types of antennas configured to the UE may be an omni-directional antenna, a parabolic antenna, a phased array antenna, etc. When the UE is configured with more than one antenna, the antenna may be configured as a plurality of antennas of a same type or a plurality of antennas of different types. For example, a UE configured with two different types of antennas may be configured with one parabolic antenna and one omni-directional antenna, or may be configured with one phased array antenna and one omnidirectional antenna, or may be configured with one parabolic antenna and one phased array antenna, or the like, which is not limited in this application. A plurality of antennas will have the same or different antenna capabilities based on a specific composition architecture, such as but not limited to antenna gain, a beam width, or the like. When the antenna configured to the UE is a non-omni-directional antenna, alignment of antenna beams/antenna (beam) steering can adopt a steering mode including electronic steering, mechanical steering, or the like, where electronic steering may be performed by configuring a phase of an antenna element, and mechanical steering may be performed by mechanically rotating an orientation of the antenna.

In the communication system, a UE behavior needs to be enhanced for UEs with different antenna configurations. For example, in scenarios of transmission, measurement, detection, monitoring, and the like in the communication system, for a UE that needs mechanical steering and/or uses a narrow beam, the communication system may consider that the UE cannot perform a corresponding behavior during a time duration required for the UE to perform mechanical steering, thus configuring corresponding restrictions. For another example, for a UE that does not need mechanical beam steering and/or uses an omni-directional antenna, because the UE does not have a UE behavior of mechanically rotating the antenna, duration required in different scenarios and expected UE behaviors of the communication system is different. For example, in scenarios of handover, radio link monitoring, beam failure detection, candidate beam detection, intra-frequency measurement, inter-frequency measurement, transmission configuration indicator (TCI) state switching, and the like, UEs may be classified based on the antenna configuration and/or composition architecture of the device, and the above scenarios can be enhanced accordingly based on different classifications.

According to the antenna configuration and/or composition architecture (or referred to as antenna configuration architecture) of the device, the UEs may be classified into different types, for example, which may also be referred to as different UE types, UE capabilities, UE power levels, UE antenna capabilities, and the like, or more generally, may be referred to as information associated with the antenna configuration of UE, and the like, but it is not limited thereto. The beneficial effects of this classification are that it is convenient for the communication system to define different UE behaviors for different types of UEs, to ensure that the different types of UEs apply different measurement requirements in RRC_CONNECTED state, and enhance the compatibility of the communication system with the different types of UEs, and improve the overall efficiency.

Table 1 below is an example of a possible classification of UE types.

TABLE 1

| UE | |
|---|---|
| type | UE antenna configuration architecture |
| 1 | UE that uses an omni-directional antenna and does not need |
| | to perform mechanical steering to adjust antenna alignment |
| 2 | UE that uses a phased array antenna and does not need to |
| | perform mechanical steering to adjust antenna alignment |
| 3 | UE that uses a single phased array or a single parabolic antenna |
| | and needs to perform mechanical steering to adjust antenna |
| | alignment |
| 4 | UE that uses a plurality of phased array and/or parabolic antennas, |
| | needs to perform circuit switching between the antennas, and needs |
| | to perform mechanical steering to adjust antenna alignment |
| 5 | UE that uses a plurality of phased array and/or parabolic antennas, |
| | does not need to perform circuit switching between the antennas, |
| | and needs to perform mechanical steering to adjust antenna |
| | alignment |

In Table 1 above, “using a plurality of phased arrays and/or parabolic antennas” may also be expressed as using a plurality of antennas, where each antenna of the plurality of antennas may include (or may be) a phased array antenna or a parabolic antenna. The plurality of antennas may be two or more antennas. In a case of dual antennas, the dual antennas may include two phased array antennas, or may include two parabolic antennas, or may include one phased array antenna and one parabolic antenna. The situation of more than two antennas is similar. This will not be described again herein.

Enhancement of a handover process is described in detail below.

When a user equipment (UE) is in a connected state (RRC_CONNECTED), it can be handed over from one cell to another through a cell handover process or a cell conditional handover process.

A specific process for the UE to perform cell handover is as follows.

When the UE receives a radio resource control (RRC) message (which may be referred to as a handover message or a handover command or a first message herein, for example), implying the UE to perform cell handover to a new cell, the UE shall be ready to start the transmission of a new uplink Physical Random Access Channel (PRACH) (e.g., uplink transmission to the new cell (e.g., a target cell)) within D_{handover} milliseconds (ms) (for example, which may be referred to as first handover time herein) from the end of the last transmission time interval (TTI) containing the RRC command, where D_{handover} may be determined based on an applicable RRC procedure delay, interruption time, and a newly added time interval (for example, which may be referred to as first time herein) which is used to describe antenna steering (related) time required by the UE during handover and/or time required for the device to perform circuit switching between different antennas. For example, D_{handover} may be equal to the applicable RRC procedure delay plus the interruption time plus the newly added time interval (for example, which may be referred to as first time herein) which is used to describe the antenna steering time required by the UE during handover and/or the time required for the device to perform circuit switching between the different antennas. This time interval may be added within the interruption time, or after the interruption time, that is, it may be expressed independently of the interruption time. When the time interval is added, it may be set to different time durations to adapt to different behaviors required by different types of UEs in handover, thus increasing the overall handover efficiency of the communication system.

Herein, antenna steering may also be referred to as beam steering, mechanical rotation, and the like.

A possible description of this newly added time interval is shown in the following equation (1).

T_{antenna-adjust}=M×Tᵣₒₜₐₜᵢₒₙ+N×T_{switch} [Equation 1]
where:
T_{antenna-adjust} is the above newly added time interval, describing the antenna steering time required during handover and/or the time required for the device to perform circuit switching between the different antennas;
M is a quantity of times of mechanical steering (or adjustment) required by the UE antenna during handover;
Tᵣₒₜₐₜᵢₒₙ is time required for single mechanical steering (or antenna steering) of the UE antenna during handover;
N is a quantity of times required for the UE to perform circuit switching between antennas during handover; and
T_{switch} is time required for single circuit switching of the UE antenna during handover.

As described according to the UE type in the above example and the equations in the above example, a possible corresponding antenna steering time interval mapping relationship may be shown in the following Table 2.

TABLE 2

| UE type | Newly added time interval, such as T_{antenna-adjust} |
|---|---|
| 1 | T_{antenna-adjust} = 0 or M = 0, N = 0 or not applicable |
| 2 | T_{antenna-adjust} = 0 or M = 0, N = 0 or not applicable |
| 3 | T_{antenna-adjust} = 3*Tᵣₒₜₐₜᵢₒₙ or M = 3, N = 0 |
| 4 | T_{antenna-adjust} = 1*Tᵣₒₜₐₜᵢₒₙ + 3*T_{switch} or M = 1, N = 3 |
| 5 | T_{antenna-adjust} = 1*Tᵣₒₜₐₜᵢₒₙ or M = 1, N = 0 |

It should be understood that the numerical values of the parameters (e.g., M, N, etc.) shown herein are merely examples, and they may have any numerical values depending on specific implementations.

The interruption time is the time between end of the last TTI containing the RRC command on the old Physical Downlink Shared Channel (PDSCH) and the time the UE starts transmission of the new PRACH, excluding the RRC procedure delay.

When cell handover is ordered to be performed, the interruption time should be less than a time duration Tᵢₙₜₑᵣᵣᵤₚₜ. If the above newly added time interval describing the antenna steering time required during handover and/or the time required for the device to perform circuit switching between the different antennas, for example, T_{antenna-adjust}, is added within the interruption time, the description of the interruption time is shown in the following equation (2).

Tᵢₙₜₑᵣᵣᵤₚₜ=T_{search}+T_{IU}+T_{processing}+T_{Δ}+T_{margin}+T_{antenna-adjust} [Equation 2]
where:
T_{search} is the time required to search the target cell when the target cell is not already known when the handover command (for example, the above first message or command) is received by the UE (for example, which may be referred to as first search time herein). If the target cell is known, then T_{search}=0 ns.
If the target cell is a Frequency Range 1 (FR1 for short) cell: if the target cell is an unknown intra-frequency cell, and the target cell Es/Iot (a ratio of useful signal on a symbol to interference and noise) is ≥−2 dB, then T_{search}=Tᵣₛ milliseconds. If the target cell is an unknown inter-frequency cell and the target cell Es/Iot is ≥−2 dB, then T_{search}=3×Tᵣₛ milliseconds.
If the target cell is a Frequency Range 2 (FR2 for short) cell: if the target cell is an unknown intra-frequency cell, and the target cell Es/Iot≥−2 dB, then T_{search}=N×Tᵣₛ milliseconds. If the target cell is an unknown inter-frequency cell, and the target cell Es/Iot≥−2 dB, then T_{search}=3×N×Tᵣs milliseconds. A value of N may be determined based on a classification type of the UE and/or a type of the target cell. Compared with that the value of N depends only on the type of target cell, the new method for determining the value can reduce handover time and improve the system efficiency while being compatible with different types of UEs. In some implementations, N may be an integer greater than or equal to 0.
If the target cell is a non-terrestrial network Frequency Range 2 Satellite Access Node (SAN for short): if the target cell is an unknown intra-frequency cell, and the target cell Es/Iot is −2 dB, then T_{search}=N×Tᵣₛ milliseconds. If the target cell is an unknown inter-frequency cell, and the target cell Es/Iot≥−2 dB, then T_{search}=3×N×Tᵣₛ milliseconds. A value of N may be determined based on a classification type of the UE and/or a type of the target cell. Compared with that the value of N depends only on the type of target cell, the new method for determining the value can reduce handover time and improve the system efficiency while being compatible with different types of UEs. In some implementations, N may be an integer greater than or equal to 0.

Taking the non-terrestrial network (NTN) FR2 Satellite Access Node (SAN for short) as the target cell, based on the aforementioned possible UE type classification example (for example, Table 1), Table 3 below shows a mapping relationship between possible values of N and the UE type classification.

TABLE 3

| UE type | N value |
|---|---|
| 1 | N = 1 |
| 2 | N = 8 |
| 3 | N = 1 |
| 4 | N = 1 |
| 5 | N = 1 |

In this example, it can be seen that if the original N=8 is reused, Tsearch time of all UEs of different types is the same. After introducing a mapping value based on the UE type, for UE types 3, 4 and 5, the corresponding N is 1, which greatly reduces time required for searching a target cell corresponding to these UEs, reduces the interruption time, and improves the overall efficiency of the communication system.

In some implementations, N may also be implicitly embodied. For example, in the case of the above-mentioned “If the target cell is a non-terrestrial network Frequency Range 2 Satellite Access Node (SAN for short): if the target cell is an unknown intra-frequency cell, and the target cell Es/Iot is ≥−2 dB, then T_{search}=N×Tᵣₛ milliseconds. If the target cell is an unknown inter-frequency cell, and the target cell Es/Iot≥−2 dB, then T_{search}=3×N×Tᵣₛ milliseconds”, for the UE types 3, 4 and 5, the above search time may also be written as T_{search}=Tᵣₛ milliseconds and T_{search}=3×Tᵣₛ milliseconds, respectively. In the embodiments of the present disclosure, the search time may be determined based on the information associated with the antenna configuration of the UE, and there is no limitation in expression.

With continued reference to the equation (2) above, where,
T is the interruption uncertainty in acquiring the first available PRACH occasion in the new cell;
T_{processing} is time for UE processing;
T_{Δ} is time for fine time tracking and acquiring full timing information of the target cell;
T_{margin} is time for synchronized signal block (SSB) post-processing;
T_{antenna-adjust} is the above newly added time interval, describing the antenna steering time required during handover and/or the time required for the device to perform circuit switching between the different antennas; and
Tᵣₛ is the SMTC (SSB-based measurement timing configuration) periodicity of the target cell. The SMTC periodicity may be provided to the UE through a handover command. If the above periodicity is not provided to the UE, the periodicity may be determined by using any existing or future method. For example, Tᵣₛ may be the SMTC configured in the measObjectNR having the same SSB frequency and subcarrier spacing. For another example, if such measObjectNR (NR Measurement Object Message) configured by a master node (MN) and a secondary node (SN) of the UE have different SMTCs, then Tᵣₛ is a periodicity of one of the SMTCs, which depends on the UE implementation, and the like. This is not limited in this application.

In the interruption request, a cell is known if it has been meeting the relevant cell identification requirements during the last (or referred to as latest) 5 seconds, otherwise it is unknown. Specific distinguishing conditions of known and unknown cells may be determined by using any existing or future method. This is not limited herein.

A specific process for the UE to perform cell conditional handover is as follows:

When the UE receives a RRC message implying the UE to perform cell conditional handover to a new cell, the UE shall be ready to start the transmission of the new uplink PRACH channel (e.g., uplink transmission to the new cell (e.g., a target cell)) within D_{CHO} seconds from the end of the last transmission time interval (TTI) containing the RRC command. Based on the existing DCHO time, a newly added time interval is added to describe the antenna steering time required by the UE during handover and/or the time required for the device to perform circuit switching between the different antennas. When the time interval is added, it may be set to different time durations to adapt to different behaviors required by different types of UEs in handover, thus increasing the overall handover efficiency of the communication system.

An example of adding this time interval, such as T_{antenna-adjust}, to DCHO is shown in the following equation (3).

D_{CHO}=T_{RRC}+T_{Event_DU}+Tₘₑₐₛᵤᵣₑ+Tᵢₙₜₑᵣᵣᵤₚₜ+T_{CHO_execution}+T_{antenna-adjust} [Equation 3]
where:
T_{RRC} is an applicable RRC procedure delay;
T_{Event_DU} is the delay uncertainty which is the time from when the UE successfully decodes a conditional handover command until a condition exists at the measurement reference point which will trigger the conditional handover;
Tₘₑₐₛᵤᵣₑ is measurement time;
T_{CHO_execution} is the conditional execution preparation time;
Tᵢₙₜₑᵣᵣᵤₚₜ is interruption time; and
T_{antenna-adjust} is the above newly added time interval, describing the antenna steering time required during handover and/or the time required for the device to perform circuit switching between the different antennas.

A possible description of this newly added time interval is shown in the following equation (4).

T_{antenna-adjust}=M×Tᵣₒₜₐₜᵢₒₙ+N×T_{switch} [Equation 4]
where:
T_{antenna-adjust} is the above newly added time interval, describing the antenna steering time required during handover and/or the time required for the device to perform circuit switching between the different antennas;
M is a quantity of times of mechanical steering (or adjustment) required by the UE antenna during handover;
Tᵣₒₜₐₜᵢₒₙ is time required for single mechanical steering (or antenna steering) of the UE antenna during handover;
N is a quantity of times required for the UE to perform circuit switching between antennas during handover; and
T_{switch} is time required for single circuit switching of the UE antenna during handover.

As described according to the UE type in the above example and the equations in the above example, a possible corresponding antenna steering time interval mapping relationship may be shown in the following Table 4.

TABLE 4

| UE type | Newly added time interval, such as T_{antenna-adjust} |
|---|---|
| 1 | T_{antenna-adjust} = 0 or M = 0, N = 0 or not applicable |
| 2 | T_{antenna-adjust} = 0 or M = 0, N = 0 or not applicable |
| 3 | T_{antenna-adjust} = 3*Tᵣₒₜₐₜᵢₒₙ or M = 3, N = 0 |
| 4 | T_{antenna-adjust} = 1*Tᵣₒₜₐₜᵢₒₙ + 3*T_{switch} or M = 1, N = 3 |
| 5 | T_{antenna-adjust} = 1*Tᵣₒₜₐₜᵢₒₙ or M = 1, N = 0 |

### Radio Link Monitoring (RLM)

The user equipment (UE) shall monitor the downlink radio link quality based on the reference signal configured as reference signal for RLM (RLM-RS) resource(s) in order to detect the downlink radio link quality of the current serving cell. The configured RLM-RS resources may be all SSBs, or all channel-state information reference signals (CSI-RSs), or a mix of SSBs and CSI-RSs. The UE is not required to perform RLM outside the activated downlink bandwidth part (DL BWP).

On each RLM-RS resource, the UE shall estimate the downlink radio link quality and compare it to the thresholds Qₒᵤₜ and Qᵢₙ for the purpose of monitoring downlink radio link quality of the cell. The threshold Qₒᵤₜ is defined as the level at which the downlink radio link cannot be reliably received, and the threshold Qᵢₙ is defined as the level at which the downlink radio link quality can be received with significantly higher reliability than at Qₒᵤₜ.

For SSB-based radio link monitoring:

The UE shall be able to evaluate whether the downlink radio link quality on the configured RLM-RS resource estimated over the last T_{Evaluate_out_SSB} millisecond period becomes worse than the threshold Q_{out_SSB} within T_{Evaluate_out_SSB} evaluation period.

The UE shall be able to evaluate whether the downlink radio link quality on the configured RLM-RS resource estimated over the last T_{Evaluate_in_SSB} millisecond period becomes better than the threshold Q_{in_SSB} within T_{Evaluate_in_SSB} evaluation period.

Here, Q_{out_SSB} and Q_{in_SSB} are respectively Qₒᵤₜ and Qᵢₙ for SSB-based radio link monitoring, which are defined in the standard.

For FR2, definitions of the above evaluation time (also referred to as evaluation period herein) T_{Evaluate_out_SSB} and T_{Evaluate_in_SSB} are shown in the following Table 5.

TABLE 5

| Configuration | T_{Evaluate}_{_{—}}ₒᵤₜ_{_{—}}_{SSB} (milliseconds) | T_{Evaluate}_{_{—}}ᵢₙ_{_{—}}_{SSB} (milliseconds) |
|---|---|---|
| Discontinuous | Max(200, Ceil(10 × | Max(100, Ceil(5 × |
| reception cycle | P × N) × T_{SSB}) | P × N) × T_{SSB}) |
| (DRX cycle for | | |
| short) | | |
| DRX cycle ≤ | Max(200, Ceil(15 × P × | Max(100, Ceil(7.5 × P × |
| 320 milliseconds | N) × Max(T_{DRX}, T_{SSB})) | N) × Max(T_{DRX}, T_{SSB})) |
| DRX cycle > | Ceil(10 × P × N) × T_{DRX} | Ceil(5 × P × N) × T_{DRX} |
| 320 milliseconds | | |

Note:
T_{SSB} is the periodicity of the SSB configured for RLM. T_{DRX} is the DRX cycle length.
P is a quantity of RLM-RS resources defined in the standard; and
N is scaling factor defined in the standard. For a UE without configuration of highSpeedMeasFlagFR2-r17, when a frequency range is FR2-1, N = 8; and when the frequency range is FR2-2, N = 12.

For the scaling factor N in the above evaluation time, when RLM is performed on SAN cells, for a UE that needs mechanical steering and/or uses narrow beams, the scaling factor N during the above evaluation period may be set to 1. For example, based on the UE type in the previous examples, when an RLM target cell is a SAN, for a UE with a UE type 3, 4, or 5, a beam that can be used by it is a fixed beam pointing towards the SAN, so that only an evaluation time with the scaling factor N=1 is needed. For a UE with a UE type 1, it uses an omni-directional antenna and does not need to consider evaluation of multiple beams, so that its scaling factor is N=1. For a UE with a UE type 2, it uses a phased array antenna that can perform electronic steering, so that a value of existing scaling factor may be taken: that is, N=8 when the frequency range is FR2-1; and N=12 when the frequency range is FR2-2.

By setting the scaling factor N=1 for the UE that needs mechanical steering and/or uses narrow beams, or introducing the mapping relationship between the N value and the UE type, compared to existing schemes that determine the evaluation time scaling factor N only based on the frequency range, for specific UE types, expected evaluation duration of the system can be shortened, unnecessary evaluation time loss can be reduced, and the overall efficiency of the communication system can be improved.

In some implementations, N may also be implicitly embodied. For example, for a case of the above “when RLM is performed on SAN cells, for a UE that needs mechanical steering and/or uses narrow beams, the scaling factor N during the above evaluation period may be set to 1. For example, based on the UE type in the previous examples, when an RLM target cell is a SAN, for a UE with a UE type 3, 4, or 5, a beam that can be used by it is a fixed beam pointing towards the SAN, so that only an evaluation time with the scaling factor N=1 is needed”, for the UE types 3, 4, and 5, the evaluation time in the above Table 5 is also written as in Table 6 below. In the embodiments of the present disclosure, the evaluation time may be determined based on the information associated with the antenna configuration of the UE, and there is no limitation in expression. In some implementations, the scaling factor may also be determined based on factors such as a frequency range, whether it is a high-speed train scenario, and the like. This is not limited herein.

TABLE 6

| Configuration | T_{Evaluate}_{_{—}}ₒᵤₜ_{_{—}}_{SSB} (milliseconds) | T_{Evaluate}_{_{—}}ᵢₙ_{_{—}}_{SSB} (milliseconds) |
|---|---|---|
| Discontinuous | Max(200, Ceil(10 × | Max(100, Ceil(5 × |
| reception cycle | P) × T_{SSB}) | P) × T_{SSB}) |
| (DRX cycle for | | |
| short) | | |
| DRX cycle ≤ | Max(200, Ceil(15 × P) × | Max(100, Ceil(7.5 × P) × |
| 320 milliseconds | Max(T_{DRX}, T_{SSB})) | Max(T_{DRX}, T_{SSB})) |
| DRX cycle > | Ceil(10 × P) × T_{DRX} | Ceil(5 × P) × T_{DRX} |
| 320 milliseconds | | |

Note:
T_{SSB} is the periodicity of the SSB configured for RLM. T_{DRX} is the DRX cycle length.
P is a quantity of RLM-RS resources defined in the standard.

Based on the aforementioned UE types, a possible mapping relationship between the UE types and the scaling factor N defined in the evaluation duration is shown in Table

TABLE 7

| UE type | N value |
|---|---|
| 1 | N = 1 |
| 2 | When a frequency range is FR2-1, |
| | N = 8; and when the frequency |
| | range is FR2-2, N = 12. |
| 3 | N = 1 |
| 4 | N = 1 |
| 5 | N = 1 |

Similarly, for a link recovery procedure:

The UE shall assess the downlink radio link quality of a serving cell based on the reference signal (RS) in a set q̅₀ as specified in the standard order to detect beam failure. The RS resource configuration in the set q̅₀ may be periodic CSI-RS resources and/or SSBs. On each RS resource configuration in the set q̅₀, the UE shall estimate the radio link quality and compare it to the threshold Q_{out_LR} for the purpose of accessing downlink radio link quality of the serving cell beams.

The threshold Q_{out_LR} is defined as the level at which the downlink radio link of a given resource configuration cannot be reliably received and shall correspond to the block error rate (BLER) BLERₚᵤₜ=10% of a hypothetical PDCCH transmission.

Upon request, the UE shall deliver configuration indexes from the set, and the corresponding Layer 1 reference signal received power (L1-RSRP) measurement to higher layers according to the standard requirements, provided that the measured L1-RSRP is equal to or better than the threshold Q_{in_LR}, which is indicated by higher layer parameter.

For SSB-based beam failure detection (BFD for short):

The UE shall be able to evaluate whether the downlink radio link quality on the configured SSB resources in set q̅₀ estimated over the last T_{Evaluate_BFD_SSB} millisecond period becomes worse than the threshold Q_{out_LR_SSB} within T_{Evaluate_BFD_SSB} millisecond period. Here, Q_{out_LR_SSB} is Q_{out_LR} for SSB-based beam failure detection, which is defined in the standard.

For FR2, the above evaluation period T_{Evaluate_BFD_SSB} is defined in the standard as shown in Table 8 below.

TABLE 8

| Configuration | T_{Evaluate}_{_{—}}_{BFD}_{_{—}}_{SSB} (milliseconds) |
|---|---|
| No DRX | Max(50, Ceil(5 × PxN) × T_{SSB}) |
| DRX cycle ≤ 320 ms | Max(50, Ceil(7.5 × P × N) × Max(T_{DRX}, T_{SSB}) |
| DRX cycle > 320 ms | Ceil(5 × P × N) × T_{DRX} |

Note:
T_{SSB} is the periodicity of the SSB in the set q̅₀. T_{DRX} is the DRX cycle length.
P is a quantity of BFD-RS resources defined in the standard; and N is scaling factor defined in the standard. For a UE without configuration of highSpeedMeasFlagFR2-r17, when a frequency range is FR2-1, N = 8; and when the frequency range is FR2-2, N = 12.

Similarly, for the scaling factor N in the above evaluation time, when beam failure detection is performed on SAN cells, for a UE that needs mechanical steering and/or uses narrow beams, the scaling factor N during the above evaluation period may be set to 1. For example, based on the UE type in the previous examples, when an BFD target cell is a SAN, for a UE with a UE type 3, 4, or 5, a beam that can be used by it is a fixed beam pointing towards the SAN, so that only an evaluation time with the scaling factor N=1 is needed. For a UE with a UE type 1, it uses an omni-directional antenna and does not need to consider evaluation of multiple beams, so that its scaling factor is N=1. For a UE with a UE type 2, it uses a phased array antenna that can perform electronic steering, so that a value of existing scaling factor may be taken: that is, N=8 when the frequency range is FR2-1; and N=12 when the frequency range is FR2-2.

By setting the scaling factor N=1 for the UE that needs mechanical steering and/or uses narrow beams, or introducing the mapping relationship between the N value and the UE type, compared to existing schemes that determine the evaluation time scaling factor N only based on the frequency range, for specific UE types, expected evaluation duration of the system can be shortened, unnecessary evaluation time loss can be reduced, and the overall efficiency of the communication system can be improved.

In some implementations, N may also be implicitly embodied. For example, for a case of the above “when beam failure detection is performed on SAN cells, for a UE that needs mechanical steering and/or uses narrow beams, the scaling factor N during the above evaluation period may be set to 1. For example, based on the UE type in the previous examples, when an BFD target cell is a SAN, for a UE with a UE type 3, 4, or 5, a beam that can be used by it is a fixed beam pointing towards the SAN, so that only an evaluation time with the scaling factor N=1 is needed”, for the UE types 3, 4, and 5, the evaluation time in the above Table 7 is also written as in Table 9 below. In the embodiments of the present disclosure, the evaluation time may be determined based on the information associated with the antenna configuration of the UE, and there is no limitation in expression. In some implementations, the scaling factor may also be determined based on factors such as a frequency range, an application scenario (for example, whether it is a high-speed train scenario), and the like. This is not limited in this application.

TABLE 9

| Configuration | T_{Evaluate}_{_{—}}_{BFD}_{_{—}}_{SSB} (milliseconds) |
|---|---|
| No DRX | Max(50, Ceil(5 × P) × T_{SSB}) |
| DRX cycle ≤ 320 ms | Max(50, Ceil(7.5 × P) × Max(T_{DRX}, T_{SSB}) |
| DRX cycle > 320 ms | Ceil(5 × P) × T_{DRX} |

Note:
T_{SSB} is the periodicity of the SSB in the set q̅₀. T_{DRX} is the DRX cycle length.
P is a quantity of BFD-RS resources defined in the standard.

Based on the aforementioned UE types, a possible mapping relationship between the UE types and the scaling factor N defined in the evaluation duration is shown in Table 10 below.

TABLE 10

| UE Type | N value |
|---|---|
| 1 | N = 1 |
| 2 | When a frequency range is FR2-1, N = 8; and |
| | when the frequency range is FR2-2, N = 12. |
| 3 | N = 1 |
| 4 | N = 1 |
| 5 | N = 1 |

Similarly, for candidate beam detection (CBD for short):

For SSB-based candidate beam detection (CBD):

Upon request, the UE shall be able to evaluate whether the L1-RSRP measured on the configured SSB resources in set q̅₁ estimated over the last T_{Evaluate_CBD_SSB} millisecond plus T_{fine_roation} millisecond period becomes better than the threshold Q_{in_LR} where the T_{fine_rotation} period is time of beam mechanical adjustment required by the UE using a mechanical steering beam.

For FR 2, the period is defined in the standard as shown in Table 11 below.

TABLE 11

| Configuration | T_{Evaluate}_{_{—}}_{CBD}_{_{—}}_{SSB} (milliseconds) |
|---|---|
| Non-DRX, DRX | Max(25, Ceil(3 × P × N × P_{CBD}) × T_{SSB} |
| cycle ≤ 320 ms | |
| DRX cycle > 320 ms | Ceil(3 × P × N × P_{CBD}) × T_{DRX} |

Note:
T_{SSB} is the periodicity of the SSB in the set q̅₁. T_{DRX} is the DRX cycle length.
P is a quantity of CBD-RS resources defined in the standard; and N is scaling factor defined in the standard. When a frequency range is FR2-1, N = 8; and when the frequency range is FR2-2, N = 12.

Similarly, for the scaling factor N in the above evaluation time, when candidate beam detection is performed on SAN cells, for a UE that needs mechanical steering and/or uses narrow beams, the scaling factor N during the above evaluation period may be set to 1. Meanwhile, for a UE that needs a mechanical steering beam, an additional time interval, such as T_{fine_rotation}, needs to be added to adapt to time in which the UE performs mechanical steering.

For example, based on the UE type in the previous examples, when an CBD target cell is a SAN, for a UE with a UE type 3, 4, or 5, a beam that can be used by it is a fixed beam pointing towards the SAN, so that only an evaluation time with the scaling factor N=1 is needed. For a UE with a UE type 1, it uses an omni-directional antenna and does not need to consider evaluation of multiple beams, so that its scaling factor is N=1. For a UE with a UE type 2, it uses a phased array antenna that can perform electronic steering, so that a value of existing scaling factor may be taken: that is, N=8 when the frequency range is FR2-1; and N=12 when the frequency range is FR2-2. Meanwhile, for a UE with a UE type 3, 4, or 5, an additional time duration, for example, T_{fine_rotation}, for antenna mechanical steering needs to be added. For a UE with a UE type 1 or 2, there is no need to add the additional time, or the additional time is 0.

In some implementations, N may also be implicitly embodied. For example, for a case of the above “when an CBD target cell is a SAN, for a UE with a UE type 3, 4, or 5, a beam that can be used by it is a fixed beam pointing towards the SAN, so that only an evaluation time with the scaling factor N=1 is needed”, for the UE types 3, 4, and 5, the evaluation time in the above Table 9 is also written as in Table 12 below. In the embodiments of the present disclosure, the evaluation time may be determined based on the information associated with the antenna configuration of the UE, and there is no limitation in expression.

TABLE 12

| Configuration | T_{Evaluate}_{_{—}}_{CBD}_{_{—}}_{SSB} (milliseconds) |
|---|---|
| Non-DRX, DRX | Max(25, Ceil(3 × P × P_{CBD}) × T_{SSB}) |
| cycle ≤ 320 ms | |
| DRX cycle > 320 ms | Ceil(3 × P × P_{CBD}) × T_{DRX} |

Note:
T_{SSB} is the periodicity of the SSB in the set q̅₁. T_{DRX} is the DRX cycle length.
P is a quantity of CBD-RS resources defined in the standard.

By setting the scaling factor N=1 for the UE that needs mechanical steering and/or uses narrow beams, or introducing the mapping relationship between the N value and the UE type, compared to existing schemes that determine the evaluation time scaling factor N only based on the frequency range, for specific UE types, expected evaluation duration of the system can be shortened, unnecessary evaluation time loss can be reduced, and the overall efficiency of the communication system can be improved.

By introducing an additional time duration, such as T_{fine_rotation}, a UE that needs mechanical steering can have enough time duration to complete mechanical adjustment of the beam and complete candidate beam detection. By mapping this time duration with the antenna configuration or the type of UE, evaluation time of a UE that does not need to perform beam steering through mechanical steering can be reduced. This can enhance the overall efficiency of the communication system while being compatible with UE types with different antenna configurations.

Based on the aforementioned UE types, a possible mapping relationship between the UE types and the scaling factor N defined in the evaluation duration and newly added mechanical steering time is shown in Table 13 below.

TABLE 13

| UE type | N value | T_{fine}_{_{—}}ᵣₒₜₐₜᵢₒₙ |
|---|---|---|
| 1 | N = 1 | 0 or not applicable |
| 2 | When a frequency range is FR | 0 or not applicable |
| | 2-1, N = 8; and when the | |
| | frequency range is FR2-2, N = 12. | |
| 3 | N = 1 | T_{fine}_{_{—}}ᵣₒₜₐₜᵢₒₙ |
| 4 | N = 1 | T_{fine}_{_{—}}ᵣₒₜₐₜᵢₒₙ |
| 5 | N = 1 | T_{fine}_{_{—}}ᵣₒₜₐₜᵢₒₙ |

For candidate beam detection (CBD) based on CSI-RS:

Upon requested, the UX shall be able to evaluate whether the L1-RSRP measured on the configured CSI-RS resources in set q̅₁ estimated over the last T_{Evaluate_CBD_CSI-RS} millisecond plus T_{fine_rotation} millisecond period becomes better than the threshold Q_{in_LR} where the T_{fine_rotation} time cycle is time of beam mechanical adjustment required by the UP using a mechanical steering beam.

For FR2, the period T_{Evaluate_CBD_CSI-RS} is defined in the standard as shown in Table 14 below.

TABLE 14

| Configuration | T_{Evaluate}_{_{—}}_{CBD}_{_{—}}_{CSI-RS} (milliseconds) |
|---|---|
| Non-DRX, DRX | Max(25, Ceil(3 × P × N × P_{CBD}) × T_{CSI-RS}) |
| cycle ≤ 320 ms | |
| DRX cycle > 320 ms | Ceil(3 × P × N × P_{CBD}) × T_{DRX} |

Note:
T_{CSI-RS} is the periodicity of the CSI-RS in the set q̅₁. T_{DRX} is the DRX cycle length.
P is a quantity of CBD-RS resources defined in the standard; and N is scaling factor defined in the standard. When a frequency range is FR2-1, N = 8; and when the frequency range is FR2-2, N = 12.

Similarly, for the scaling factor N in the above evaluation time, when candidate beam detection is performed on SAN cells, for a UE that needs mechanical steering and/or uses narrow beams, the scaling factor N during the above evaluation period may be set to 1. Meanwhile, for a UE that needs a mechanical steering beam, an additional time interval, such as T_{fine_rotation}, needs to be added to adapt to time for mechanical steering.

For example, based on the UE type in the previous examples, when an CBD target cell is a SAN, for a UE with a UE type 3, 4, or 5, a beam that can be used by it is a fixed beam pointing towards the SAN, so that only an evaluation time with the scaling factor N=1 is needed. For a UE with a UE type 1, it uses an omni-directional antenna and does not need to consider evaluation of multiple beams, so that its scaling factor is N=1. For a UE with a UE type 2, it uses a phased array antenna that can perform electronic steering, so that a value of existing scaling factor may be taken: that is, N=8 when the frequency range is FR2-1; and N=12 when the frequency range is FR2-2. Meanwhile, for a UE with a UE type 3, 4, or 5, an additional time duration, for example, T_{fine_rotation}, for antenna mechanical steering needs to be added. For a UE with a UE type 1 or 2, there is no need to add the additional time, or the additional time is 0.

In some implementations, N may also be implicitly embodied. For example, for a case of the above “when an CBD target cell is a SAN, for a UE with a UE type 3, 4, or 5, a beam that can be used by it is a fixed beam pointing towards the SAN, so that only an evaluation time with the scaling factor N=1 is needed”, for the UE types 3, 4, and 5, the evaluation time in the above Table 11 is also written as in Table 15 below. In the embodiments of the present disclosure, the evaluation time may be determined based on the information associated with the antenna configuration of the UE, and there is no limitation in expression.

TABLE 15

| Configuration | T_{Evaluate}_{_{—}}_{CBD}_{_{—}}_{CSI-RS} (milliseconds) |
|---|---|
| Non-DRX, DRX | Max(25, Ceil(3 × P × P_{CBD}) × T_{CSI-RS}) |
| cycle ≤ 320 ms | |
| DRX cycle > 320 ms | Ceil(3 × P × P_{CBD}) × T_{DRX} |

Note:
T_{CSI-RS} is the periodicity of the CSI-RS in the set q̅₁. T_{DRX} is the DRX cycle length.
P is a quantity of CBD-RS resources defined in the standard.

By setting the scaling factor N=1 for the UE that needs mechanical steering and/or uses narrow beams, or introducing the mapping relationship between the N value and the UE type, compared to existing schemes that determine the evaluation time scaling factor N only based on the frequency range, for specific UE types, expected evaluation duration of the system can be shortened, unnecessary evaluation time loss can be reduced, and the overall efficiency of the communication system can be improved.

By introducing an additional time duration, such as T_{fine_rotation}, a UE that needs mechanical steering can have enough time duration to complete mechanical steering of the beam and complete candidate beam detection. By mapping this time duration with the antenna configuration or the type of UE, evaluation time of a UE that does not need to perform beam steering through mechanical steering can be reduced. This can enhance the overall efficiency of the communication system while being compatible with UE types with different antenna configurations.

Based on the aforementioned UE types, a possible mapping relationship between the UE types and the scaling factor N defined in the evaluation duration and newly added mechanical steering time is shown in Table 16 below.

TABLE 16

| UE type | N value | T_{fine}_{_{—}}ᵣₒₜₐₜᵢₒₙ |
|---|---|---|
| 1 | N = 1 | 0 or not applicable |
| 2 | When a frequency range is FR2-1, | 0 or not applicable |
| | N = 8; and when the frequency | |
| | range is FR2-2, N = 12. | |
| 3 | N = 1 | T_{fine}_{_{—}}ᵣₒₜₐₜᵢₒₙ |
| 4 | N = 1 | T_{fine}_{_{—}}ᵣₒₜₐₜᵢₒₙ |
| 5 | N = 1 | T_{fine}_{_{—}}ᵣₒₜₐₜᵢₒₙ |

A time interval and a timer (such as, D_{handover}, T_{antenna-adjust}, T_{search}, T_{Evaluate_XXX}, etc.) mapping to (or corresponding to) the UE types in the various scenarios or procedures as described above may be set by both sides of the UE and the network respectively based on a UE type reported by the UE (or referred to as information associated with the antenna configuration of the UE). For example, the UE can determine, based on its own UE type (for example, the antenna configuration related type as described above), various time intervals, timers, etc. in the various scenarios as described above, and each base station or node on the network side can also determine, based on a UE type related to an antenna configuration reported by the UE, various time intervals, timers, etc. in the various scenarios as described above. In some implementations, the base station may also determine various timer information based on information that is associated with the antenna configuration of the UE and that is reported by the UE, and then configure it to the UE.

FIG. 4 illustrates an example interaction flow between a UE and a network regarding a UE type according to embodiments of the present disclosure.

As shown in FIG. 4, an interactive way of the UE type or antenna capability as described above may be that in step 401, when a network needs (additional) UE radio access capability information (for example, the antenna configuration related type or capability of the UE as described above), the network may initiate procedures such as UE capability query or requesting (for example, UECapabilityEnquiry) to the UE in a RRC connected state (for example, RRC_CONNECTED). In step 402, in response to UE capability query or requesting initiated by the network, the UE may report radio access capability information of the UE (for example, the antenna configuration related type or capability of the UE as described above) to the network, for example, through a UECapabilitylnformation message. In some implementations, the UE may report its radio access capability information autonomously. In this case, step 401 may be omitted.

In some implementations, the UE type or antenna capability may be implemented by newly adding corresponding information elements in the above UECapabilitylnformat ion message, or expanding existing information elements (such as RF-Parameters, etc.).

In an embodiment, the UECapabilitylnformation message may include information associated with the antenna configuration of the UE, where the information associated with the antenna configuration of the UE may indicate either a first UE type that the UE perform electronic antenna steering, or a second UE type that the UE perform mechanical antenna steering.

In an embodiment, the UECapabilityInformation message may include information associated with the antenna configuration of the UE that indicates either a first UE type that the UE perform electronic antenna steering, or a second UE type that the UE perform mechanical antenna steering.

Next, FIG. 5a illustrates a flowchart of a method 500 performed by a user equipment in a wireless communication system according to embodiments of the present disclosure.

As shown in FIG. 5a, the method 500 performed by the UE in the wireless communication system according to embodiments of the present disclosure may include: in step S501, receiving, from a node, a first message for indicating the UE to perform cell handover; and in step S502, performing uplink transmission to a target cell within first handover time from the end of a last transmission time interval including the first message. In some implementations, the first handover time may include first time including time related to antenna steering required by the UE during handover and/or time required for circuit switching between different antennas. In some implementations, the first time may be determined based on information associated with an antenna configuration of the UE.

According to embodiments of the present disclosure, the first time is determined based on one or more of: a quantity of times of steering a UE antenna during handover, time required for the UE antenna to perform single antenna steering during handover, a quantity of times for the UE to perform circuit switching between antennas during handover, and time required for the UE antenna to perform single circuit switching during handover.

According to embodiments of the present disclosure, the first handover time includes first interruption time, where the first interruption time includes first search time required to search for a target cell when the UE receives the first message and the target cell is unknown, and where the first search time is determined based on the information associated with the antenna configuration of the UE.

According to embodiments of the present disclosure, the first time is included in the first interruption time.

According to embodiments of the present disclosure, if the target cell is a Frequency Range 2 cell, the first search time is determined based on an N value and a synchronization signal block-based measurement timing configuration (SMTC) cycle of the target cell, where the N value is determined based on the information associated with the antenna configuration of the UE, where the N value is an integer greater than or equal to 0.

According to embodiments of the present disclosure, if the information associated with the antenna configuration of the UE indicates that the UE is a UE that needs to perform mechanical steering to adjust antenna alignment, the N value is equal to 1.

According to embodiments of the present disclosure, if the information associated with the antenna configuration of the UE indicates that the UE is a UE that needs to perform mechanical steering to adjust antenna alignment, the first search time is determined based on a synchronization signal block-based measurement timing configuration (SMTC) cycle of the target cell.

According to embodiments to the present disclosure, the target cell may be a non-terrestrial network (NTN) Frequency Range 2 (FR2) satellite access node (SAN). In an embodiment, the UE may perform the handover from a NR SAN FR1 cell to a NR SAN FR1 cell during the first handover time.

FIG. 5b illustrates a flowchart of a method 510 performed by a user equipment in a wireless communication system according to embodiments of the present disclosure.

As shown in FIG. 5b, the method 510 performed by the UE in the wireless communication system according to embodiments of the present disclosure may include: in step S511, receiving a first reference signal from, for example, a base station or a node; and in step S512, evaluating the first reference signal within first evaluation time. In some implementations, the first reference signal may be a reference signal used for at least one of radio link monitoring, beam failure detection, or candidate beam detection. In some implementations, the first evaluation time may be determined based on information associated with an antenna configuration of the UE. In some implementations, the first evaluation time may be determined based on scaling factor. In some implementations, the scaling factor may be determined based on the information associated with the antenna configuration of the UE.

According to embodiments of the present disclosure, the first evaluation time is determined based on scaling factor, and where the scaling factor is determined based on at least one of a frequency range, an application scenario, or the information associated with the antenna configuration of the UE.

According to embodiments of the present disclosure, in a case that the first reference signal is a reference signal for radio link monitoring, beam failure detection, and/or candidate beam detection of a satellite access node (SAN) cell, and the information associated with the antenna configuration of the UE indicates that the UE is a UE that needs to perform mechanical steering to adjust antenna alignment, the scaling factor is 1.

According to embodiments of the present disclosure, in a case that the first reference signal is a reference signal for candidate beam detection of a satellite access node (SAN) cell, and the information associated with the antenna configuration of the UE indicates that the UE is a UE that needs to perform mechanical steering to adjust antenna alignment, the first evaluation time further includes additional time for the UE to perform antenna steering.

According to embodiments of the present disclosure, the information associated with the antenna configuration of the UE includes one or more of: indicating a UE that uses an omni-directional antenna and does not need to perform mechanical steering to adjust antenna alignment; indicating a UE that uses a phased array antenna and does not need to perform mechanical steering to adjust antenna alignment; indicating a UE that uses a single phased array or a single parabolic antenna and needs to perform mechanical steering to adjust antenna alignment; indicating a UE that uses a plurality of antennas, needs to perform circuit switching between the antennas, and needs to perform mechanical steering to adjust antenna alignment, where each of the plurality of antennas includes a phased array or parabolic antenna; indicating a UE that uses a plurality of phased array and/or parabolic antennas, does not need to perform circuit switching between the antennas, and needs to perform mechanical steering to adjust antenna alignment.

According to embodiments of the present disclosure, the information associated with the antenna configuration of the UE includes one or more of: indicating a type of an antenna used by the UE; and indicating a quantity of antennas used by the UE, where the type includes an omni-directional antenna, a phased array antenna, or a parabolic antenna, and the quantity includes one or more.

According to embodiments of the present disclosure, the information associated with the antenna configuration of the UE further includes at least one of: indicating that the UE needs to perform circuit switching between antennas; indicating that the UE does not need to perform circuit switching between antennas; indicating that the UE needs to perform mechanical steering to adjust antenna alignment; or indicating that the UE does not need to perform mechanical steering to adjust antenna alignment.

According to embodiments of the present disclosure, the first reference signal includes at least one of a synchronization signal block (SSB) or a channel state information reference signal (CSI-RS).

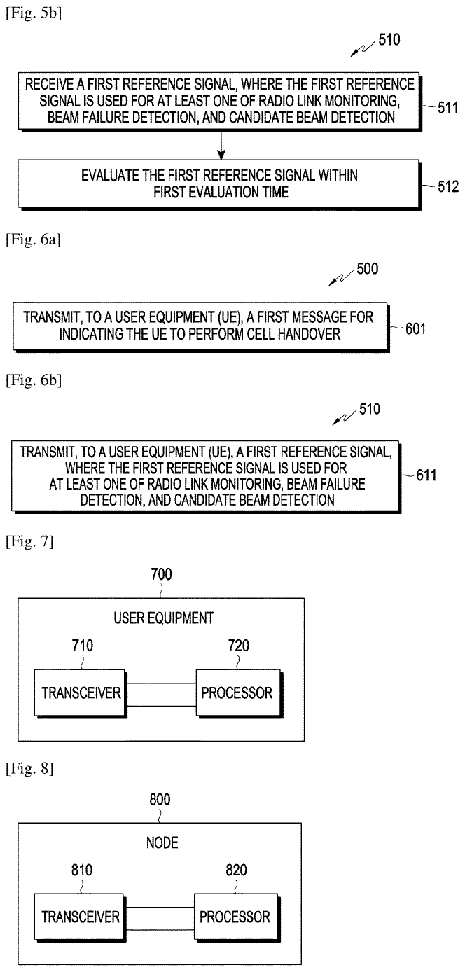

FIG. 6a illustrates a flowchart of a method 600 performed by a node in a wireless communication system according to embodiments of the present disclosure.

As shown in FIG. 6a, the method 600 performed by the node in the wireless communication system according to embodiments of the present disclosure may include: in step S601, transmitting, to a user equipment (UE), a first message for indicating the UE to perform cell handover. In some implementations, the UE may perform uplink transmission to a target cell within first handover time from the end of a last transmission time interval including the first message. In some implementations, the first handover time may include time related to antenna steering required by the UE during handover and/or time required for circuit switching between different antennas. In some implementations, the first time may be determined based on information associated with an antenna configuration of the UE.

According to embodiments of the present disclosure, the first time is determined based on one or more of: a quantity of times of steering a UE antenna during handover, time required for the UE antenna to perform single antenna steering during handover, a quantity of times for the UE to perform circuit switching between antennas during handover, and time required for the UE antenna to perform single circuit switching during handover.

According to embodiments of the present disclosure, the first handover time includes first interruption time, where the first interruption time includes first search time required to search for a target cell when the UE receives the first message and the target cell is unknown, and where the first search time is determined based on the information associated with the antenna configuration of the UE.

According to embodiments of the present disclosure, the first time is included in the first interruption time.

According to embodiments of the present disclosure, if the target cell is a Frequency Range 2 cell, the first search time is determined based on an N value and a synchronization signal block-based measurement timing configuration (SMTC) cycle of the target cell, where the N value is determined based on the information associated with the antenna configuration of the UE, where the N value is an integer greater than or equal to 0.

According to embodiments of the present disclosure, if the information associated with the antenna configuration of the UE indicates that the UE is a UE that needs to perform mechanical steering to adjust antenna alignment, the N value is equal to 1.

According to embodiments of the present disclosure, if the information associated with the antenna configuration of the UE indicates that the UE is a UE that needs to perform mechanical steering to adjust antenna alignment, the first search time is determined based on a synchronization signal block-based measurement timing configuration (SMTC) cycle of the target cell.

FIG. 6b illustrates a flowchart of a method 610 performed by a node in a wireless communication system according to embodiments of the present disclosure.

As shown in FIG. 6b, the method 610 performed by the node in the wireless communication system according to embodiments of the present disclosure may include: in step S611, transmitting, to a user equipment (UE), a first reference signal. In some implementations, the UE may evaluate the first reference signal within first evaluation time. In some implementations, the first reference signal may be a reference signal used for at least one of radio link monitoring, beam failure detection, or candidate beam detection. In some implementations, the first evaluation time may be determined based on information associated with an antenna configuration of the UE. In some implementations, the first evaluation time may be determined based on scaling factor. In some implementations, the scaling factor may be determined based on the information associated with the antenna configuration of the UE.

According to embodiments of the present disclosure, the first evaluation time is determined based on scaling factor, and where the scaling factor is determined based on at least one of a frequency range, an application scenario, or the information associated with the antenna configuration of the UE.

According to embodiments of the present disclosure, in a case that the first reference signal is a reference signal for radio link monitoring, beam failure detection, and/or candidate beam detection of a satellite access node (SAN) cell, and the information associated with the antenna configuration of the UE indicates that the UE is a UE that needs to perform mechanical steering to adjust antenna alignment, the scaling factor is 1.

According to embodiments of the present disclosure, in a case that the first reference signal is a reference signal for candidate beam detection of a satellite access node (SAN) cell, and the information associated with the antenna configuration of the UE indicates that the UE is a UE that needs to perform mechanical steering to adjust antenna alignment, the first evaluation time further includes additional time for the UE to perform antenna steering.

According to embodiments of the present disclosure, the information associated with the antenna configuration of the UE includes one or more of: indicating a UE that uses an omni-directional antenna and does not need to perform mechanical steering to adjust antenna alignment; indicating a UE that uses a phased array antenna and does not need to perform mechanical steering to adjust antenna alignment; indicating a UE that uses a single phased array or a single parabolic antenna and needs to perform mechanical steering to adjust antenna alignment; indicating a UE that uses a plurality of antennas, needs to perform circuit switching between the antennas, and needs to perform mechanical steering to adjust antenna alignment, where each of the plurality of antennas includes a phased array or parabolic antenna; indicating a UE that uses a plurality of phased array and/or parabolic antennas, does not need to perform circuit switching between the antennas, and needs to perform mechanical steering to adjust antenna alignment.

According to embodiments of the present disclosure, the information associated with the antenna configuration of the UE includes one or more of: indicating a type of an antenna used by the UE; and indicating a quantity of antennas used by the UE, where the type includes an omni-directional antenna, a phased array antenna, or a parabolic antenna, and the quantity includes one or more.

According to embodiments of the present disclosure, the information associated with the antenna configuration of the UE further includes at least one of: indicating that the UE needs to perform circuit switching between antennas; indicating that the UE does not need to perform circuit switching between antennas; indicating that the UE needs to perform mechanical steering to adjust antenna alignment; or indicating that the UE does not need to perform mechanical steering to adjust antenna alignment.

According to embodiments of the present disclosure, the first reference signal includes at least one of a synchronization signal block (SSB) or a channel state information reference signal (CSI-RS).

Next, FIG. 7 illustrates a schematic diagram of a user equipment 700 in a wireless communication system according to embodiments of the present disclosure.

As shown in FIG. 7, the user equipment 700 according to embodiments of the present disclosure may include a transceiver 710 and a processor 720. The transceiver 710 may be configured to transmit and receive a signal. The processor 720 may be coupled with the transceiver 710 and may be configured to (e.g., control the transceiver 710 to) perform any method performed by the user equipment in the wireless communication system according to embodiments of the present disclosure.

FIG. 8 illustrates a schematic diagram of a node 800 in a wireless communication system according to embodiments of the present disclosure.

As shown in FIG. 8, the node 800 (such as a base station) according to embodiments of the present disclosure may include a transceiver 810 and a processor 820. The transceiver 810 may be configured to transmit and receive a signal. The processor 820 may be coupled with the transceiver 810 and may be configured to (e.g., control the transceiver 810 to) perform any method performed by the node according to embodiments of the present disclosure. Herein, a processor may also be referred to as a controller.

The node mentioned in the present disclosure may include network entities or network logic units such as a base station, a gNB, a gNB central unit (gNB-CU), a gNB distributed unit (gNB-DU), a gNB-CU-Control Plane (gNB CU-CP), gNB-CU-User Plane (gNB CU-UP), an en-gNB, an eNB, an ng-eNB, a UE, a access and mobility management function (AMF), a session management function (SMF), and a mobility management entity (MME).

Embodiments of the present disclosure provide a computer-readable medium having stored computer-readable instructions thereon, which when executed by a processor, are used to implement the method performed by the user equipment (UE) and/or the node in the wireless communication system according to embodiments of the present disclosure.

Embodiments of the present disclosure provide a node and a user equipment in a wireless communication system and methods performed by the same. UEs are classified based on antenna configurations of the UEs. This can help the communication system to define different UE behaviors for different types of UEs, to ensure that the different types of UEs apply different requirements in connected state measurement, and enhance the compatibility of the communication system with the different types of UEs, and improve the overall efficiency.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media may be distributed by computer systems connected via a network, and thus computer-readable codes may be stored and executed in a distributed manner. Furthermore, functional programs, codes and code segments for implementing various embodiments of the present disclosure may be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium may be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1-15. (canceled)

16. A method performed by a user equipment (UE) in a wireless communication system, comprising:
receiving, from a node, a first message for indicating the UE to perform a cell handover; and
transmitting, to a target cell, an uplink physical random access channel (PRACH) based on a first handover time duration from an end of a last transmission time interval including the first message,
wherein the first handover time duration includes a first time duration related to antenna steering required by the UE during a handover, and
wherein the first time duration is related to capability information associated with an antenna steering type of the UE.

17. The method of claim 16, wherein the first time duration is related to at least one of:
a quantity of times of steering a UE antenna during handover, time required for the UE antenna to perform single antenna steering during handover,
a quantity of times for the UE to perform circuit switching between antennas during handover, or
a time duration required for the UE antenna to perform single circuit switching during handover.

18. The method of claim 16, wherein the first handover time duration includes an interruption time duration, and
wherein the interruption time duration includes a search time duration required to search for the target cell in case that the UE receives the first message and the target cell is unknown.

19. The method of claim 18, wherein the first time duration is included in the interruption time duration; and
wherein the target cell is a non-terrestrial network (NTN) Frequency Range 2 (FR2) satellite access node (SAN).

20. The method of claim 18, wherein, based on the target cell being a Frequency Range 2 cell, the search time duration is related to an N value and a synchronization signal block (SSB)-based measurement timing configuration (SMTC) cycle of the target cell,
wherein the N value is related to the capability information associated with the antenna steering type of the UE, and
wherein the N value is an integer greater than or equal to 0.

21. The method of claim 20, wherein, based on the capability information associated with the antenna steering type of the UE indicating that the UE is a UE type that needs to perform mechanical steering to adjust antenna alignment, the N value is equal to 1.

22. The method of claim 18, wherein, based on the capability information associated with the antenna steering type of the UE indicating that the UE is a UE type that needs to perform mechanical steering to adjust antenna alignment, the search time duration is related to a SMTC cycle of the target cell.

23. The method of claim 16, further comprising:
transmitting, to the node, a UE capability information message including the capability information associated with the antenna steering type of the UE,
wherein the capability information associated with the antenna steering type of the UE indicates either a first UE type that the UE performs electronic antenna steering, or a second UE type that the UE performs mechanical antenna steering.

24. The method of claim 16, wherein the capability information associated with the antenna steering type of the UE comprises at least one of:
information indicating a type of an antenna used by the UE; or
information indicating a quantity of antennas used by the UE,
wherein the type comprises at least one of an omni-directional antenna, a phased array antenna, or a parabolic antenna, or the quantity comprises one or more.

25. The method of claim 16, wherein the capability information associated with the antenna steering type of the UE includes at least one of:
information indicating that the UE needs to perform circuit switching between antennas;
information indicating that the UE does not need to perform circuit switching between antennas;
information indicating that the UE needs to perform mechanical steering to adjust antenna alignment; or
information indicating that the UE does not need to perform mechanical steering to adjust antenna alignment.

26. The method of claim 16, further comprising:
receiving a first reference signal, wherein the first reference signal is used for at least one of radio link monitoring, beam failure detection, or candidate beam detection; and
evaluating the first reference signal within an evaluation time duration,
wherein the evaluation time duration is related to capability information associated with the antenna steering type of the UE.

27. The method of claim 26, wherein the evaluation time duration is related to scaling factor, and wherein the scaling factor is related to at least one of a frequency range, an application scenario, or the capability information associated with the antenna steering type of the UE, and
wherein the first reference signal includes at least one of a synchronization signal block (SSB) or a channel state information reference signal (CSI-RS).

28. A method performed by a node in a wireless communication system, comprising:
transmitting, to a user equipment (UE), a first message for indicating the UE to perform a cell handover,
wherein the first message causes the UE to transmit an uplink physical random access channel (PRACH) to a target cell based on a first handover time duration from the end of a last transmission time interval including the first message,
wherein the first handover time duration includes a first time duration related to antenna steering required by the UE during a handover, and
wherein the first time duration is related to capability information associated with an antenna steering type of the UE.

29. The method of claim 28, wherein the first handover time duration includes an interruption time duration, and
wherein the interruption time duration includes a search time duration required to search for the target cell in case that the UE receives the first message and the target cell is unknown.

30. The method of claim 29, wherein the first time duration is included in the interruption time duration; and
wherein the target cell is a non-terrestrial network (NTN) Frequency Range 2 (FR2) satellite access node (SAN).

31. The method of claim 28, further comprising:
receiving, from the UE, a UE capability information message including the capability information associated with the antenna steering type of the UE,
wherein the capability information associated with the antenna steering type of the UE indicates either a first UE type that the UE performs electronic antenna steering, or a second UE type that the UE performs mechanical antenna steering.

32. The method of claim 28, wherein the capability information associated with the antenna steering type of the UE includes at least one of:
information indicating that the UE needs to perform circuit switching between antennas;
information indicating that the UE does not need to perform circuit switching between antennas;
information indicating that the UE needs to perform mechanical steering to adjust antenna alignment; or
information indicating that the UE does not need to perform mechanical steering to adjust antenna alignment.

33. A user equipment (UE) in a wireless communication system, comprising:
a transceiver; and
at least one processor, coupled with the transceiver and configured to:
receive, from a node, a first message for indicating the UE to perform a cell handover, and
transmit, to a target cell, an uplink physical random access channel (PRACH) based on a first handover time duration from the end of a last transmission time interval including the first message,
wherein the first handover time duration includes a first time duration related to antenna steering required by the UE during a handover, and
wherein the first time duration is related to capability information associated with an antenna steering type of the UE.

34. The UE of claim 29, wherein the capability information associated with the antenna steering type of the UE includes at least one of:
information indicating that the UE needs to perform circuit switching between antennas;
information indicating that the UE does not need to perform circuit switching between antennas;
information indicating that the UE needs to perform mechanical steering to adjust antenna alignment; or
information indicating that the UE does not need to perform mechanical steering to adjust antenna alignment.

35. A node in a wireless communication system, comprising:
a transceiver; and
at least one processor, coupled with the transceiver and configured to transmit, to a user equipment (UE), a first message for indicating the UE to perform a cell handover,
wherein the first message causes the UE to transmit an uplink physical random access channel (PRACH) to a target cell based on a first handover time duration from the end of a last transmission time interval including the first message,
wherein the first handover time duration includes a first time duration related to antenna steering required by the UE during a handover, and
wherein the first time duration is related to capability information associated with an antenna steering type of the UE.
